(19) United States
(12) Patent Application Publication
(10) Pub. No.: US 2008/0084922 A1
(43) Pub. Date: Apr. 10, 2008

(54) Multiprotocol multiplex wireless communication apparatus and methods

(76) Inventors: Bendik Kleveland, Sunnyvale, CA (US); David Friedman, Sunnyvale, CA (US); Stanley B-T Wang, Sunnyvale, CA (US); Thomas Lee, Sunnyvale, CA (US); Carl Gyllenhammer, Sunnyvale, CA (US)

Correspondence Address: Edouard Garcia;Attorney At Law, 501 Palmer Lane, Menlo Park, CA, 94025-1941, US

(21) Appl. No.: 11/543,508

(22) Filed: Oct. 5, 2006

(51) Int. Cl. H04B 3/36; H04L 27/00

(52) U.S. Cl. 375/211; 375/259

(57) ABSTRACT

Multiprotocol multiplex wireless communication apparatus and methods are described. These apparatus and methods are capable of simultaneously communicating with multiple wireless environments in accordance with different wireless communications protocols. In particular, these apparatus and methods are capable of transmitting and receiving multiplex signals that include constituent data-carrying signals that conform to different wireless communications protocols.

### BACKGROUND

Wireless communications involve the transmission and reception of wireless signals. These communications may be one-way communications or two-way communications. Standard wireless communications modules have been developed to transition between the wireless transmission medium (usually air) and the electronic components inside wireless communication devices. A communications module may be integrally incorporated within a host system or a host system component (e.g., a network interface card (NIC)) or it may consist of a separate component that readily may be plugged into and unplugged from a host system. Communication modules include transmitter modules, receiver modules, and transceiver modules.

Each communications module produces a standardized output to the host device in accordance with a compatible wireless communications protocol. In general, a wireless communications protocol is any format, definition, or specification that specifies the content or nature of data that is transmitted or the link over which the data is transmitted. A wireless communications protocol typically includes transmission rate specifications, wireless link specifications, frame formats, blocking formats, text formats, stop/start indicators, framing and heading indicators, field definitions, checksum values, and carriage return and line feed (CRJLF) indicators. Many different wireless communications protocols have been developed. In the area of short-range wireless communications, Bluetooth and IEEE 802.11 wireless local area networking protocols recently have attracted the most interest.

With the proliferation of different wireless communications protocols, there has arisen a need for devices to communicate with a wide variety of wireless communication devices using different wireless communications protocols. This need coupled with the desire to reduce the size, power requirements, and cost have led to the development of single-chip transceivers that are capable of communicating in accordance with different wireless communications protocols. In one approach, a single chip includes a separate transceiver integrated circuit for each wireless communication protocol. In another approach, a single chip includes dual-mode transceiver circuits that can be selectively reconfigured to handle wireless communications in accordance with multiple wireless protocols. In each of these approaches, a switch is used to selectively enable wireless communications in accordance with only one of the wireless communications protocols at a time.

What are needed are apparatus and method that are capable of simultaneously communicating with multiple radio environments in accordance with different wireless communications protocols.

### SUMMARY

In one aspect, the invention features a wireless communication apparatus that includes a demultiplexing down-conversion stage and a multiprotocol baseband receiver stage. The demultiplexing down-conversion stage receives a multiplex input signal that includes a first carrier modulated with a first data signal and a second carrier modulated with a second data signal. The first and second carrier signals are in quadrature. The demultiplexing down-conversion stage down-converts the multiplex input signal to produce a first demultiplexed signal corresponding to the first data signal in a baseband frequency range. The demultiplexing down-conversion stage also down-converts the multiplex input signal to produce a second demultiplexed signal corresponding to the second data signal in the baseband frequency range. The multiprotocol baseband receiver stage produces from the first demultiplexed signal a first receive data signal that conforms to a first wireless communications protocol. The multiprotocol baseband receiver stage produces from the second demultiplexed signal a second receive data signal that conforms to a second wireless communications protocol that is different from the first wireless communications protocol.

In another aspect, the invention features a wireless communication apparatus that includes a multiprotocol baseband transmitter stage and a multiplexing up-conversion stage. The multiprotocol baseband transmitter stage produces a first baseband transmit signal from a first transmit data signal that conforms to a first wireless communications protocol. The multiprotocol baseband transmitter stage also produces a second baseband transmit signal from a second transmit data signal that conforms to a second wireless communications protocol that is different from the first wireless communications protocol. The multiplexing up-conversion stage is coupled to the multiprotocol baseband transmitter stage. The multiplexing up-conversion stage up-converts the first baseband transmit signal to a first up-converted signal in a selected wireless transmission frequency range. The multiplexing up-conversion stage up-converts the second baseband transmit signal to a second up-converted signal in the selected wireless transmission frequency range such that the first and second up-converted signals are in quadrature. The multiplexing up-conversion stage combines the first and second up-converted signals into a multiplex output signal.

In another aspect, the invention features a wireless communication method in accordance with which a multiplex input signal is received. The multiplex input signal includes a first carrier modulated with a first data signal and a second carrier modulated with a second data signal, where the first and second carrier signals are in quadrature. The multiplex input signal is down-converted to produce a first demultiplexed signal corresponding to the first data signal in a baseband frequency range. The multiplex input signal also is down-converted to produce a second demultiplexed signal corresponding to the second data signal in the baseband frequency range. A first receive data signal that conforms to a first wireless communications protocol is produced from the first demultiplexed signal. A second receive data signal that conforms to a second wireless communications protocol that is different from the first wireless communications protocol is produced from the second demultiplexed signal.

In another aspect, the invention features a wireless communication method in accordance with which a first baseband transmit signal is produced from a first transmit data signal that conforms to a first wireless communications protocol. A second baseband transmit signal is produced from a second transmit data signal that conforms to a second wireless communications protocol different from the first wireless communications protocol. The first baseband transmit signal is up-converted to produce a first up-converted signal in an RF frequency range. The second baseband transmit signal is up-converted to produce a second up-converted signal in the RF frequency range, where the first and second up-converted signals are in quadrature. The first and second up-converted signals are combined into a multiplex output signal.

Other features and advantages of the invention will become apparent from the following description, including the drawings and the claims.

### DESCRIPTION OF DRAWINGS

FIG. 1 is a block diagram of an embodiment of a wireless receiver communication apparatus that includes a demultiplexing down-conversion stage and a multiprotocol baseband receiver stage in an exemplary operational environment.

FIG. 2 is a flow diagram of an embodiment of a wireless communication method.

FIG. 3 is a schematic diagram of an embodiment of the demultiplexing down-conversion stage shown in FIG. 1.

FIG. 4 is a block diagram of an embodiment of the multiprotocol baseband receiver stage of FIG. 1 that includes a multiprotocol signal processing stage and an analog-to-digital interface stage.

FIG. 5 is a block diagram of an embodiment of the multiprotocol signal processing stage shown in FIG. 4.

FIG. 6 is a schematic diagram of an embodiment of an amplification stage that includes first and second amplification circuits and a gain controller.

FIG. 7 is a timing diagram of first and second data signals that are multiplexed into a transmitted multiplex signal in accordance with an embodiment of the invention.

FIG. 8 is a schematic diagram of an embodiment of a wireless receiver communication apparatus.

FIG. 9 is a block diagram of an embodiment of a wireless communication apparatus that includes a multiplexing up-conversion stage and a multiprotocol baseband transmitter stage in an exemplary operational environment.

FIG. 10 is a flow diagram of an embodiment of a wireless communication method.

FIG. 11 is a schematic diagram of an embodiment of the multiplexing up-conversion stage shown in FIG. 9.

FIG. 12 is a block diagram of an embodiment of the multiprotocol baseband transmitter stage of FIG. 9 that includes a multiprotocol signal processing stage and a digital-to-analog interface stage.

FIG. 13 is a block diagram of an embodiment of the multiprotocol signal processing stage shown in FIG. 12.

FIG. 14 is a schematic diagram of an embodiment of a wireless transmitter communication apparatus.

FIG. 15 is a block diagram of an embodiment of a wireless communication apparatus.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

### I. Overview

The embodiments that are described herein are capable of simultaneously communicating with multiple wireless environments in accordance with different wireless communications protocols. As explained in detail below, these embodiments are capable of transmitting and receiving multiplex signals that include constituent data-carrying signals that conform to different wireless communications protocols. In this way, these embodiments allow the overall data rate to be increased relative to approaches in which only one wireless communications protocol is enabled at a time.

As used herein the term “wireless” refers to any form of non-wired signal transmission, including AM and FM radio transmission, TV transmission, cellular telephone transmission, portable telephone transmission, and wireless LAN (local area network) transmission. A wide variety of different methods and technologies may be used to provide wireless transmissions in the embodiments that are described herein, including infrared line of sight methods, cellular methods, microwave methods, satellite methods, packet radio methods, and spread spectrum methods.

The wireless communication apparatus that are described herein may be implemented by relatively small, low-power, and low-cost integrated circuit stages that are integrated on a single semiconductor chip. As a result, these apparatus are highly suitable for incorporation in wireless communications environments that have significant size, power, and cost constraints, including but not limited to handheld electronic devices (e.g., a mobile telephone, a cordless telephone, a portable memory device such as a smart card, a personal digital assistant (PDA), a video camera, a still image camera, a solid state digital audio player, a CD player, an MCD player, a game controller, a pager, and a miniature still image or video camera), portable computers (e.g., laptop computers), and other embedded environments.

### II. Wireless Receiver Embodiments

A. Overview

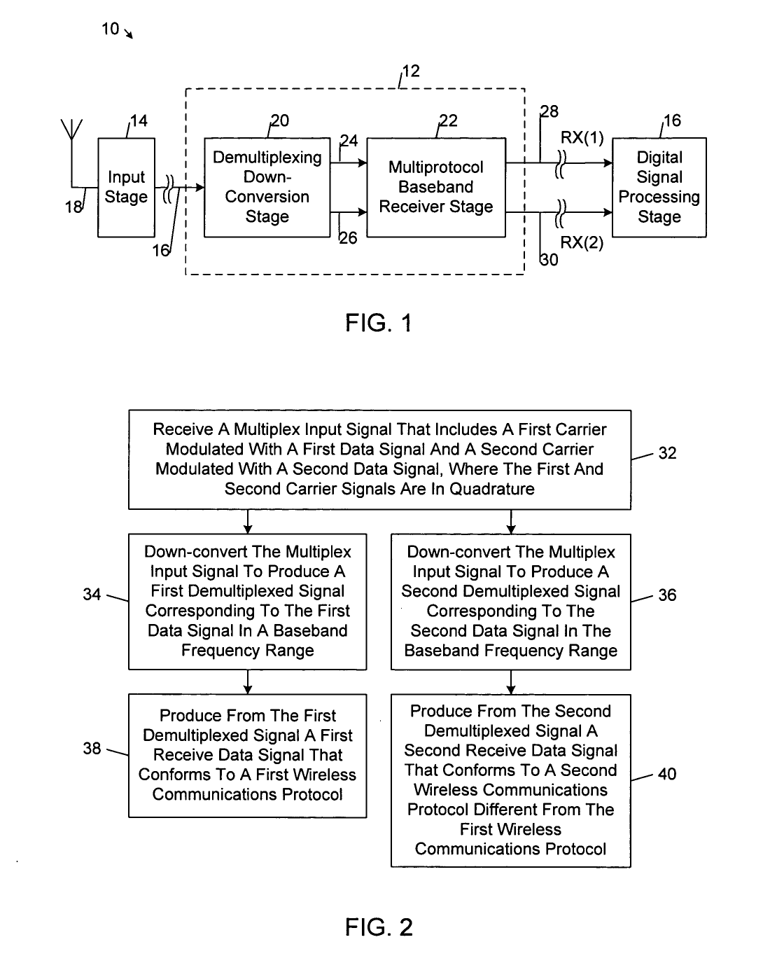

FIG. 1 shows an exemplary application environment 10 in which an embodiment of a multiprotocol multiplex wireless communication apparatus 12 may operate. The application environment 10 includes an input stage 14 and a digital signal processing stage 16. The input stage 14 produces a multiplex input signal 16 from wireless signals that are received by an antenna 18. The wireless communication apparatus 12 includes a demultiplexing down-conversion stage 20 and a multiprotocol baseband receiver stage 22. The demultiplexing down-conversion stage 20 extracts from the multiplex input signal 16 down-converted signals 24, 26 that correspond to the constituent data-carrying signals of the multiplex input signal 16. The multiprotocol baseband receiver stage 22 processes the down-converted signals 24, 26 to produce first and second receive data signals 28, 30 (RX(1), RX(2)) that conform to different respective wireless communications protocols. The digital signal processing stage 16 extracts data from the first and second receive data signals 28, 30 in accordance with the different respective wireless communications protocols that were used to encode the constituent data-carrying signals of the multiplex input signal 16.

FIG. 2 shows an embodiment of a wireless communication method that is implemented by the wireless communication apparatus 12.

In accordance with this method, the demultiplexing down-conversion stage. 20 receives the multiplex input signal 16 (FIG. 2, block 32). The multiplex input signal 16 includes a first carrier that is modulated with a first data signal and a second carrier that is modulated with a second data signal. The first and second carrier signals are in quadrature (i.e., they are ninety degrees out-of-phase with respect to each other).

The first and second data signals conform to different wireless communications protocols. Exemplary pairs of wireless communications protocols that are suitable for encoding the first and second data signals include: two different versions of the IEEE 802.11 protocol; and the IEEE 802.11 protocol and the IEEE 802/15/Bluetooth protocol. In some exemplary embodiments, the first data signal is encoded in accordance with a first communications protocol that corresponds to a standard IEEE 802.11 protocol (e.g., 802.11b or 802.11g), and the second data signal is encoded with a second communications protocol that differs from the first communications protocol only by the use of a different pseudorandom noise chip sequence to modulate the second data signal. In some of these embodiments, the first data signal is modulated by a standard IEEE 802.11 11-chip Barker code (i.e., chip sequence) with a 90.9 nanosecond chip time, and the second data signal is modulated by a different pseudorandom noise code at 90.9 nanosecond per chip. Exemplary pseudorandom codes that are suitable for modulating the second data signal include, but are not limited to, chip sequences that are longer or shorter than an 11-bit Barker pseudorandom chip sequence (e.g., a 44-chip sequence, a 22-chip sequence, and a 5-chip sequence).

The demultiplexing down-conversion stage 20 down-converts the multiplex input signal 16 to produce the first demultiplexed signal 24, which corresponds to the first data signal in a baseband frequency range (FIG. 2, block 34). The demultiplexing down-conversion stage 20 also down-converts the multiplex input signal 16 to produce the second demultiplexed signal 26, which corresponds to the second data signal in the baseband frequency range (FIG. 2, block 36). As used herein, the baseband frequency range refers to the frequency range from 0 Hertz (Hz) up to a maximum frequency that is substantially below the frequency range of the multiplex input signal 16. In typical RF applications, the maximum baseband frequency typically is below 100 MHz, whereas the maximum frequency of the multiplex input signal 16 typically is in the GHz frequency range.

The multiprotocol baseband receiver stage 22 produces from the first demultiplexed signal 24 the first receive data signal 28 (RX(1)), which conforms to the first wireless communications protocol (FIG. 2, block 38). The multiprotocol baseband receiver stage 22 also produces from the second demultiplexed signal 26 the second receive data signal 30 (RX(2)), which conforms to a second wireless communications protocol that is different from the first wireless communications protocol (FIG. 2, block 40).

B. Exemplary Embodiments of the Demultiplexing Down-Conversion Stage

In general, the demultiplexing down-conversion stage 20 shown in FIG. 1 may be implemented by any circuit that is capable of down-converting the multiplex input signal 16 to produce the first demultiplexed signal 24 and the second demultiplexed signal 26 in the baseband frequency range.

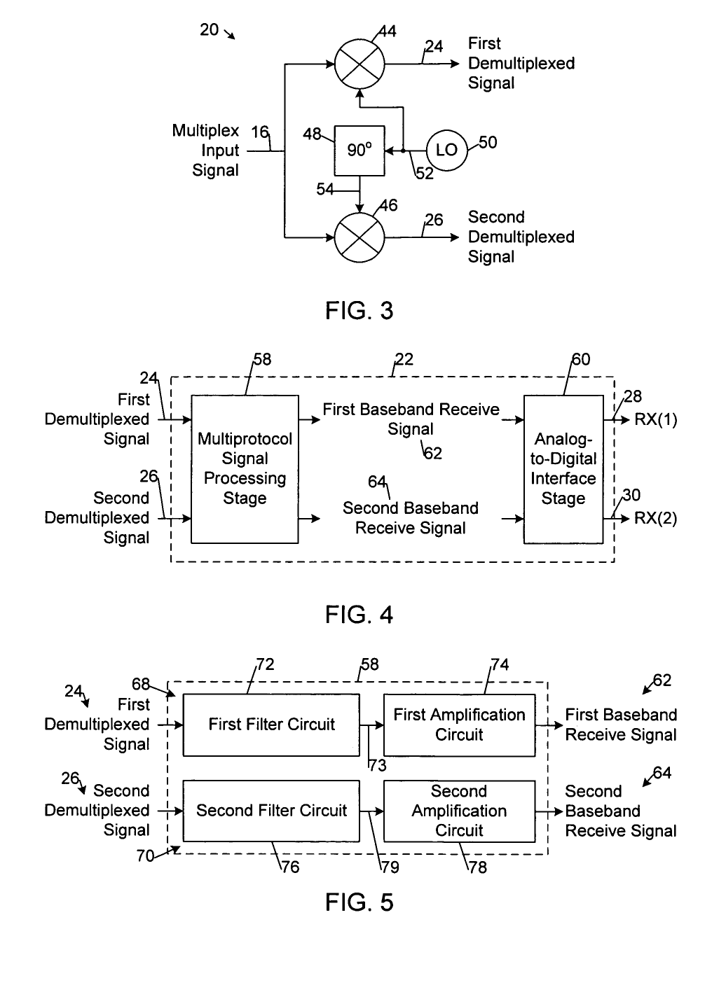

FIG. 3 shows an exemplary embodiment of the demultiplexing down-conversion stage 20 that includes a first mixer 44, a second mixer 46, a phase-shifter 48, and a local oscillator 50. The local oscillator 50 is coupled to the first mixer 44 and the phase shifter 48. The phase-shifter 48 is coupled between the local oscillator 50 and the second mixer 46.

In operation, the local oscillator 50 produces an in-phase local oscillator signal 52. The phase-shifter 48 produces an in-quadrature version 54 of the local oscillator signal 52 from the in-phase local oscillator signal 52. The first mixer 44 produces the first demultiplexed signal 24 by mixing the multiplex input signal 16 with the in-phase local oscillator signal 52. The second mixer 46 produces the second demultiplexed signal 26 by mixing the multiplex input signal 16 with the in-quadrature version 54 of the local oscillator signal 52.

In some embodiments, the first data signal is encoded in accordance with a standard version of the IEEE 802.11 protocol (e.g., 802.11b or 802.11g) and the second data signal is encoded in accordance with a different protocol, which may be a standard protocol, a modified version of a standard protocol, or a proprietary protocol. In ones of these embodiments in which the first and second data signals are encoded in accordance with different versions of the IEEE 802.11 protocol, the multiplex input signal 16 typically is a 2.4 gigahertz (GHz) RF signal, and the first and second mixers down-convert the multiplex input signal 16 to zero-IF (DC) first and second demultiplexed signals 24, 26.

In other embodiments, the first data signal is encoded in accordance with the Bluetooth (IEEE 802.15) protocol and the second data signal is encoded in accordance with the wireless LAN (IEEE 802.11) protocol. In these embodiments, the multiplex input signal 16 typically is a 2.4 gigahertz (GHz) RF signal. The first mixer down-converts the multiplex input signal 16 to a 2 megahertz (MHz) low-IF first demultiplexed signal 24. The second mixer down-converts the multiplex input signal 16 to a zero-IF (DC) second demultiplexed signal 26.

C. Exemplary Embodiments of the Multiprotocol Baseband Receiver Stage

FIG. 4 shows an embodiment of the multiprotocol baseband receiver stage 22 shown in FIG. 1. In this embodiment, the multiprotocol baseband receiver stage 22 includes a multiprotocol signal processing stage 58 and an analog-to-digital interface stage 60.

The multiprotocol signal processing stage 58 rejects interferers in the first demultiplexed signal 26 that are outside a selected first channel frequency range to produce a first baseband receive signal 62. The multiprotocol signal processing stage 58 also rejects interferers in the second demultiplexed signal 26 that are outside a selected second channel frequency range to produce a second baseband receive signal 64. The multiprotocol signal processing stage 58 may be implemented by a single dual-mode analog signal processing circuit. Alternatively, the multiprotocol signal processing stage 58 may include separate analog signal processing circuits for respectively processing the first and second demultiplexed signals 24, 26.

The analog-to-digital interface stage 60 converts the analog first baseband receive signal 62 to the digital first receive data signal 28 (RX(1)) and converts the analog second baseband receive signal 64 to the digital second receive data signal 30 (RX(2)). The analog-to-digital interface stage 60 may be implemented by a single dual-mode analog-to-digital converter circuit that is capable of digitizing both the first and second baseband receive signals 62, 64. Alternatively, the analog-to-digital interface stage 60 may include separate analog-to-digital converter circuits for respectively processing the first and second baseband receive signals 62, 64.

In some other embodiments of the multiprotocol baseband receiver stage 22 (see FIG. 1), the analog-to-digital interface stage 60 may be omitted. In these embodiments, the multiprotocol baseband receiver stage 22 outputs the first and second analog baseband receive signals 62, 64 as the first and second receive data signals 28, 30 (RX(1), RX(2)).

FIG. 5 shows an embodiment of the multiprotocol signal processing stage 58 (see FIG. 4) that includes separate analog signal processing circuit 68, 70 for respectively processing the first and second demultiplexed signals 24, 26. In this embodiment, the first analog signal processing circuit 68 includes a first filter circuit 72 and a first amplification circuit 74. The first filter circuit 72 has a tunable frequency response that is configured to filter the first demultiplexed signal 24 compatibly with the first wireless communications protocol to produce a first filtered signal 73. The first amplification circuit 74 amplifies the first filtered signal 73 compatibly with the first wireless communications protocol to produce the first baseband receive signal 62. The second analog signal processing circuit 70 includes a second filter circuit 76 and a second amplification circuit 78. The second filter circuit has a tunable frequency response that is configured to filter the second demultiplexed signal 26 compatibly with the second wireless communications protocol to produce a second filtered signal 79. The second amplification circuit 78 amplifies the second filtered signal 79 compatibly with the second wireless communications protocol to produce the second baseband receive signal 64.

In some embodiments, the first data signal is encoded in accordance with a standard version of the IEEE 802.11 protocol (e.g., 802.11b or 802.11g) and the second data signal is encoded in accordance with a different protocol, which may be a standard protocol, a modified version of a standard protocol, or a proprietary protocol. In ones of these embodiments in which the first and second data signals are encoded in accordance with different versions of the IEEE 802.11 protocol, each of the first and second filter circuits 72, 76 may be implemented by a filter with complex poles located symmetrically about a zero-IF (DC), and each of the first and second amplification circuits 74, 78 may be implemented by a variable gain amplifier circuit.

In other embodiments, the first wireless communications protocol is the Bluetooth (IEEE 802.15) protocol and the second wireless communications protocol is the wireless LAN (IEEE 802.11) protocol. In these embodiments, the first filter circuit 72 may be implemented by a filter with complex poles located symmetrically about a 2 MHz IF, and the first amplification circuit 74 may be implemented by a variable gain amplifier circuit. The second filter circuit 76 may be implemented by a filter with complex poles located symmetrically about a zero-IF (DC), and the second amplification circuit 78 may be implemented by a variable gain amplifier circuit.

D. Exemplary Circuits and Methods of Distinguishing the First and Second Baseband Receive Signals

There is a wide variety of circuits and methods for distinguishing the first and second baseband receive signals 62, 64 from each other including, but not limited to, the following exemplary embodiments. These embodiments may be used to distinguish the first and second baseband receive signals 62, 64 when the first and second data signals are encoded in accordance with different wireless communications protocols.

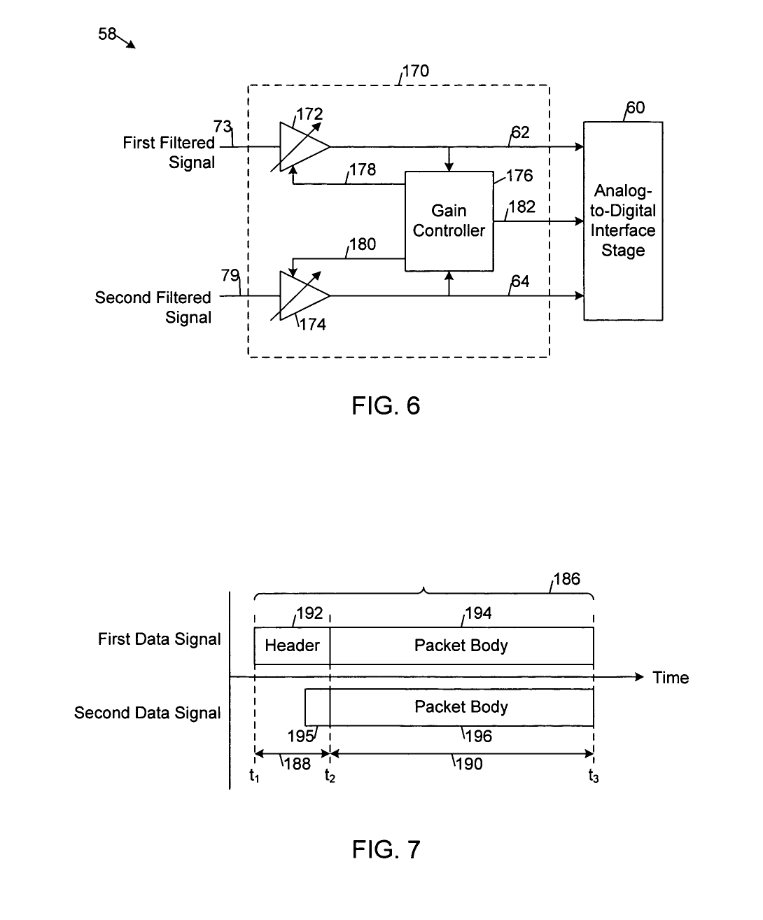

FIG. 6 shows an embodiment of an amplification stage 170 of the multiprotocol signal processing stage 58 (see FIG. 4). The amplification stage 170 includes first and second amplification circuits 172, 174 and a gain controller 176. The first and second amplification circuits 172, 174 are implemented by variable gain amplifiers whose gains are controlled by respective gain control signals 178, 180 that are set by the gain controller 176. The gain controller 176 includes one or more detector circuits that produce measurement signals indicative of the power levels of the first and second baseband receive signals 62, 64 that are output from the first and second amplification circuits, respectively. In some implementations, the detector circuits produce DC measurement signals that are proportional to the RMS (root mean square) of the power levels of first and second baseband receive signals 62, 64. The gain controller 176 sets the gain control signals 178, 180 based on an integration of the differences between the DC measurement signals and reference voltage levels. In some of these implementations, the gain controller 176 produces an output signal 182 that provides measures of the respective power levels of the first and second baseband receive signals 62, 64. In some embodiments in accordance with the invention, the first and second data carriers are multiplexed onto the multiplex input signal 16 at different power levels. In these embodiments, the gain controller output signal 182 is used by the digital signal processing stage 16 to distinguish the first and second baseband receive signals 62, 64 from each other.

In some embodiments of the wireless communications apparatus 12, the analog-to-digital interface stage 60 (see FIG. 4) includes an analog-to-digital converter that samples the first and second baseband receive signals 62, 64 and converts the sampled values to digital signals 28, 30 (i.e., RX(1), RX(2)). The is digital signal processing stage 16 (see FIG. 1) processes the resulting digital signals 28, 30. In the embodiments in which the first and second data carriers are multiplexed onto the multiplex input signal 18 at different power levels, the digital signal processing stage 16 distinguishes the first and second baseband receive signals 62, 64 from each other based on the different levels of the digital signals 28, 30.

FIG. 7 is a timing diagram of first and second data signals that are multiplexed into the received multiplex input signal 16 in accordance with an embodiment of the invention. In this embodiment, the multiplex input signal 16 is transmitted and received in the form of a series of packets 186. Each packet 186 includes a header section 188 (i.e., between times t₁ and t₂) and a body section 190 (i.e., between times t₂ and t₃). In accordance with this embodiment, the first data signal contains a longer header and is transmitter first. The first data signal includes a header 192 and a packet body 194, whereas the second data signal includes a smaller header 195 and a packet body 196. In implementations 30 of the wireless communications apparatus 12 in accordance with this embodiment, the digital signal processing stage 16 is operable to detect the header 192 in the first and second baseband receive signals 62, 64 and to distinguish the first and second baseband receive signals 62, 64 from each other based on the presence of absence of the header 192 in each packet 186. In some of the implementations, the wireless communications apparatus 12 is able to lock onto the header 192 in each received packet and selectively output one or both of the first and second baseband receive signals 62, 64.

E. Exemplary Multi-Channel Wireless Receiver Embodiments

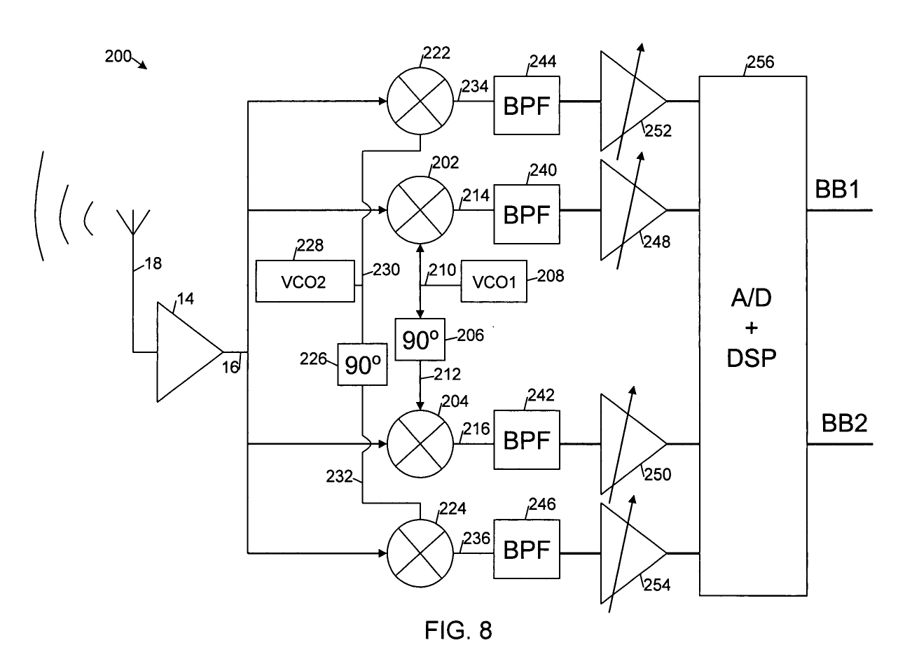

FIG. 8 is a schematic diagram of an embodiment of a multi-channel wireless receiver communication apparatus 200 that is capable of receiving instances of the multiplex input signal 16 that are encoded with first and second data signals that are multiplexed into the input signal 16 at two different channel frequencies. In this embodiment, the multiplex input signal 16 includes the first data signal (BB1) modulated onto a first carrier at a first channel frequency and the second data signal (BB2) modulated onto a second carrier at a second channel frequency.

The multi-channel wireless receiver apparatus 200 includes a first demultiplexing down-conversion stage for demultiplexing the first carrier from the multiplex input signal 16. The first demultiplexing down-conversion stage includes a first mixer 202, a second mixer 204, a phase-shifter 206, and a local oscillator 208 (VCO1). The local oscillator 208 is coupled to the first mixer 202 and the phase-shifter 206. The phase-shifter 206 is coupled between the local oscillator 208 and the second mixer 204. In operation, the local oscillator 208 produces an in-phase local oscillator signal 210. The phase-shifter 206 produces an in-quadrature version 212 of the in-phase local oscillator signal 210. The first mixer 202 produces a first demultiplexed signal 214 by mixing the multiplex input signal 16 with the in-phase local oscillator signal 210. The second mixer 204 produces a second demultiplexed signal 216 by mixing the multiplex input signal 16 with the in-quadrature version 212 of the in-phase local oscillator signal 210.

The multi-channel wireless receiver apparatus 200 also includes a second demultiplexing down-conversion stage for demultiplexing the second carrier from the multiplex input signal 16. The second demultiplexing down-conversion stage includes a third mixer 222, a fourth mixer 224, a phase-shifter 226, and a local oscillator 228 (VCO2) that operates at a different frequency than the local oscillator 208 of the first demultiplexing down-conversion stage. In some embodiments, the local oscillator 228 is implemented by a discrete oscillator circuit that is separate from the local oscillator 208. In other embodiments, the local oscillator 228 is implemented by a sideband mixer that derives the local oscillator signal 230 by mixing the local oscillator signal 210 with a second signal at a different frequency. The local oscillator 228 is coupled to the third mixer 222 and the phase-shifter 226. The phase-shifter 226 is coupled between the local oscillator 228 and the fourth mixer 224. In operation, the local oscillator 228 produces an in-phase local oscillator signal 230. The phase-shifter 226 produces an in-quadrature version 232 of the in-phase local oscillator signal 230. The third mixer 222 produces a third demultiplexed signal 234 by mixing the multiplex input signal 16 with the in-phase local oscillator signal 230. The fourth mixer 224 produces a fourth demultiplexed signal 236 by mixing the multiplex input signal 16 with the in-quadrature version 232 of the in-phase local oscillator signal 230. In this way, the second demultiplexing down-conversion stage down-converts the multiplex input signal 16 to produce the third and fourth demultiplexed signals in quadrature at a baseband frequency different from the baseband frequency of the first and second demultiplexed signals.

The first, second, third, and fourth demultiplexed signals 214, 216, 234, and 236 are passed through respective bandpass filters 240, 242, 244, 246 before being applied to the inputs of respective variable gain amplifiers 248, 250, 252, 254. The combined analog-to-digital converter and digital signal processing stage 256 digitizes the analog output signals that are produced by the variable gain amplifiers 248-254 and processes the resulting digital signals to recover the first and second data signals BB1 and BB2.

### III. Wireless Transmitter Embodiments

A. Overview

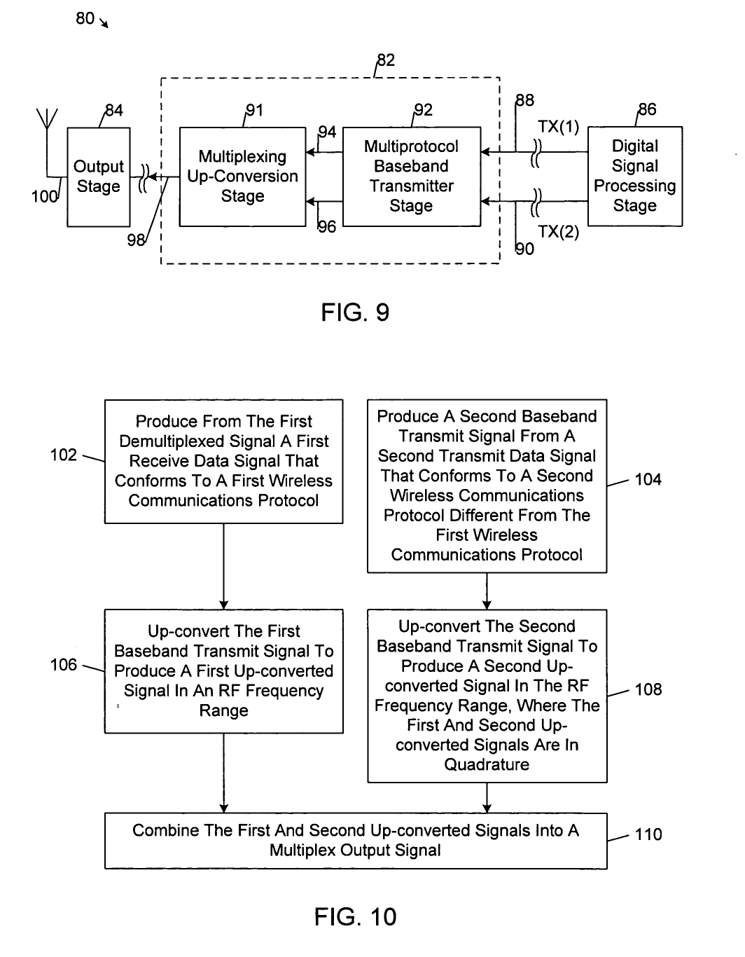

FIG. 9 shows an exemplary application environment 80 in which an embodiment of a multiprotocol multiplex wireless communication apparatus 82 may operate. The application environment 80 includes an output stage 84 and a digital signal processing stage 86. The digital signal processing stage 86 produces first and second transmit signals 88, 90 (TX(1), TX(2)) in accordance with different respective wireless communications protocols. The wireless communication apparatus 82 includes a multiprotocol baseband transmitter stage 92 and a multiplexing up-conversion stage 91. The multiprotocol baseband transmitter stage 92 processes the first and second transmit signals 88, 90 (TX(1), TX(2)) to produce first and second baseband transmit signals 94, 96. The multiplexing up-conversion stage 91 up-converts the first and second baseband transmit signals 94, 96 and combines the up-converted signals to produce a multiplex output signal 98. The output stage 84 wirelessly transmits the multiplex output signal 98 via an antenna 100.

FIG. 10 shows an embodiment of a wireless communication method that is implemented by the wireless communication apparatus 82.

The multiprotocol baseband transmitter stage 92 produces the first baseband transmit signal 94 from the first transmit data signal 88 (TX(1)), which conforms to the first wireless communications protocol (FIG. 10, block 102). The multiprotocol baseband transmitter stage 92 also produces the second baseband transmit signal 96 from the second transmit data signal 90 (TX(2), which conforms to the second wireless communications protocol (FIG. 10, block 104).

The multiplexing up-conversion stage 91 up-converts the first baseband transmit signal 94 to produce a first up-converted signal in a selected wireless transmission frequency range (FIG. 10, block 106). The multiplexing up-conversion stage 91 also up-converts the second baseband transmit signal 96 to produce a second up-converted signal in the selected wireless transmission frequency range, where the first and second up-converted signals are in quadrature (i.e., they are ninety degrees out-of-phase with respect to each other) (FIG. 10, block 108). The multiplexing up-conversion stage 91 then combines the first and second up-converted signals into the multiplex output signal 98 (FIG. 10, block 110).

B. Exemplary Embodiments of the Multiplexing Up-Conversion Stage

In general, the multiplexing up-conversion stage 91 shown in FIG. 9 may be implemented by any circuit that is capable of up-converting the first and second baseband transmit signals 94, 96 to the selected wireless transmission frequency range and capable of combining the up-converted signals to produce the multiplex output signal 98.

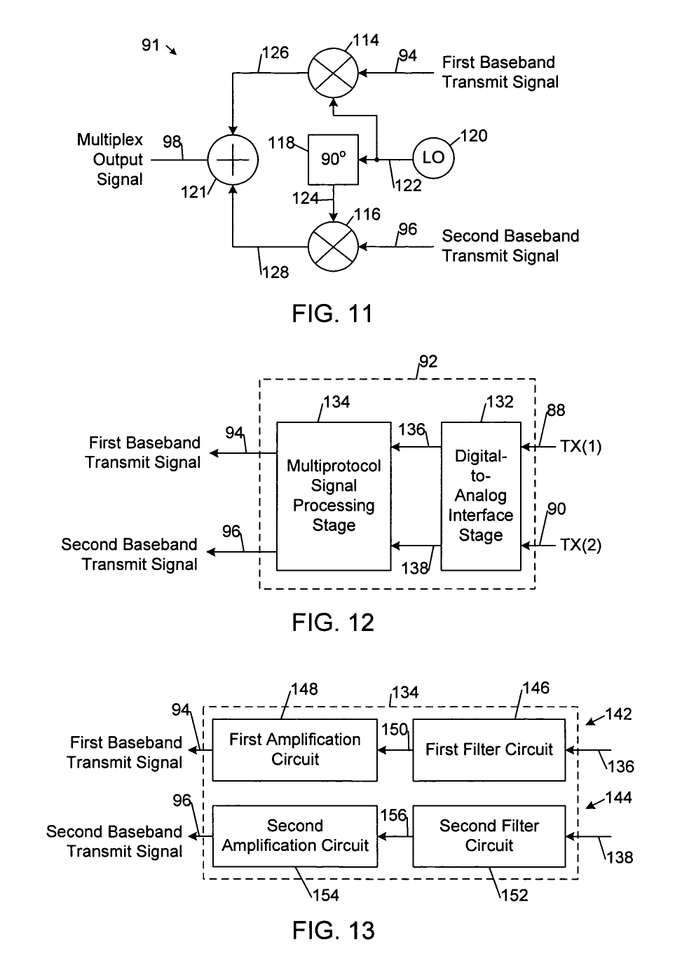

FIG. 11 shows an exemplary embodiment of the multiplexing up-conversion stage 91 that includes a first mixer 114, a second mixer 116, a phase-shifter 118, a local oscillator 120, and a summer (or adder) 121. The local oscillator 120 is coupled to the first mixer 114. The phase-shifter 118 is coupled between the local oscillator 120 and the second mixer 116.

In operation, the local oscillator 120 produces an in-phase local oscillator signal 122. The phase-shifter 118 produces an in-quadrature version 124 of the local oscillator signal 122 from the in-phase local oscillator signal 122. The first mixer 114 produces the first up-converted signal 126 by mixing the first baseband transmit signal 94 with the in-phase local oscillator signal 122. The second mixer 116 produces the second up-converted signal 128 by mixing the second baseband transmit signal 96 with the in-quadrature version 124 of the local oscillator signal 122. The summer 121 combines the first and second up-converted signals 126, 128 to produce the multiplex output signal 98.

In some embodiments, the first data signal is encoded in accordance with a standard version of the IEEE 802.11 protocol (e.g., 802.11b or 802.11g) and the second data signal is encoded in accordance with a different protocol, which may be a standard protocol, a modified version of a standard protocol, or a proprietary protocol. In ones of these embodiments in which the first and second data signals are encoded in accordance with different versions of the IEEE 802.11 protocol, the first mixer 114 up-converts the first baseband transmit signal 94 to a 2.4 gigahertz (GHz) RF up-converted signal 126, and the second mixer 116 up-converts the second baseband transmit signal 96 to a 2.4 gigahertz (GHz) RF up-converted signal 128.

In other embodiments, the first wireless communications protocol is the Bluetooth (IEEE 802.15.1) protocol and the second wireless communications protocol is the wireless LAN (IEEE 802.11) protocol. In these embodiments, the first mixer 114 up-converts the first baseband transmit signal 94 to a 2.4 gigahertz (GHz) RF up-converted signal 126. Similarly, the second mixer 116 up-converts the second baseband transmit signal 96 to a 2.4 gigahertz (GHz) RF up-converted signal 128.

C. Exemplary Embodiments of the Multiprotocol Baseband Transmitter Stage

FIG. 12 shows an embodiment of the multiprotocol baseband transmitter stage 92 shown in FIG. 6. The multiprotocol baseband transmitter stage 130 includes a digital-to-analog interface stage 132 and a multiprotocol signal processing stage 134.

The digital-to-analog interface stage 132 converts the first transmit data signal 88 (TX(1)) to an analog first transmit signal 136 and converts the second transmit data signal 90 (TX(2)) to an analog second transmit data signal 138. The digital-to-analog interface stage 132 may be implemented by a single dual-mode digital-to-analog converter circuit that is capable of converting both the first and second transmit data signals 88, 90 to respective analog signals. Alternatively, the digital-to-analog interface stage 132 may include separate digital-to-analog converter circuits for respectively processing the first and second transmit data signals 88, 90.

In some other embodiments of the multiprotocol baseband transmitter stage 92 (see FIG. 9), the digital-to-analog interface stage 132 may be omitted. In these embodiments, the multiprotocol baseband transmitter stage 92 receives the first and second transmit data signals 88, 90 (TX(1), TX(2)) in analog form.

The multiprotocol signal processing stage 134 shapes the transmit spectra of the analog transmit data signals 136, 138 and controls the amplitudes of the resulting signals to reduce loss of dynamic range. The multiprotocol signal processing stage 134 may be implemented by a single dual-mode analog signal processing circuit. Alternatively, the multiprotocol signal processing stage 134 may include separate analog signal processing circuits for respectively processing the first and second analog transmit data signals 136, 138.

FIG. 13 shows an embodiment of the multiprotocol signal processing stage 134 (see FIG. 9) that includes separate analog signal processing circuits 142, 144 for respectively processing the first and second analog transmit data signals 136, 138.

In this embodiment, the first analog signal processing circuit 142 includes a first filter circuit 146 and a first amplification circuit 148. The first filter circuit 146 has a tunable frequency response that is configured to filter the first analog transmit data signal 136 compatibly with the first wireless communications protocol to produce a first filtered signal 150. The first amplification circuit 148 amplifies the first filtered signal 150 compatibly with the first wireless communications protocol to produce the first baseband transmit signal 94.

The second analog signal processing circuit 144 includes a second filter circuit 152 and a second amplification circuit 154. The second filter circuit 152 has a tunable frequency response that is configured to filter the second analog transmit data signal 138 compatibly with the second wireless communications protocol to produce a second filtered signal 156. The second amplification circuit 154 amplifies the second filtered signal 156 compatibly with the second wireless communications protocol to produce the second baseband transmit signal 144.

D. Exemplary multi-channel wireless receiver Embodiments

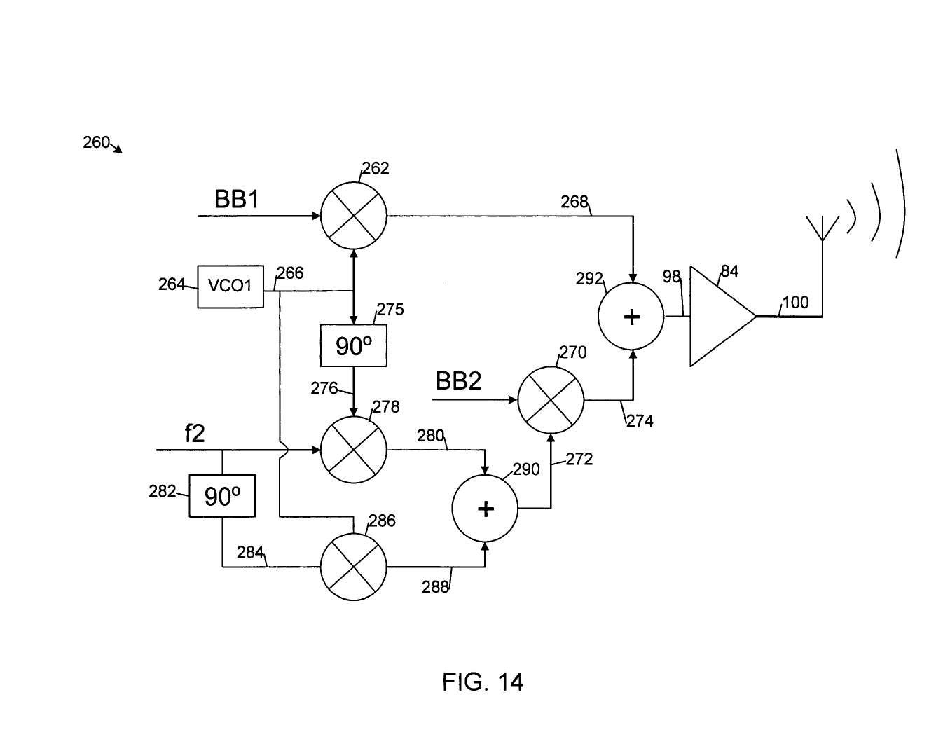

FIG. 14 is a schematic diagram of an embodiment of a multi-channel wireless transmitter communication apparatus 260 that is capable of transmitting instances of the multiplex output signal 98 that are encoded with first and second data signals that are multiplexed into the output signal 98 at two different channel frequencies. In this embodiment, the multiplex output signal 98 includes the first data signal (BB1) that is modulated onto a first carrier at a first channel frequency and the second data signal (BB2) that is modulated onto a second carrier at a second channel frequency.

The multi-channel wireless transmitter apparatus 200 includes a first up-conversion circuit for up-converting the first data signal (BB1) to a first carrier frequency (the frequency of VCO1) and a second up-conversion circuit for up-converting the second data signal (BB2) to a second carrier frequency (the frequency of VCO2). The first up-conversion circuit includes a first mixer 262 and a local oscillator 264. In operation, the local oscillator 264 produces an in-phase local oscillator signal 266. The first mixer 262 produces a first up-converted signal 268 by mixing the first data signal BB1 with the in-phase local oscillator signal 266. The second up-conversion circuit includes a second mixer 270 and a second local oscillator signal 272 (VCO2). In operation, the second mixer 270 produces a second up-converted signal 274 by mixing the second data signal BB2 with the second local oscillator signal 272. In this way, the first and second up-conversion circuits are operable to up-convert the first and second baseband signals such that the first and second up-converted signals have different respective channel frequencies.

The multi-channel wireless transmitter apparatus 200 additionally includes a summer 292 that combines the first and second up-converted signals 268, 274 to produce the multiplex output signal 98.

In the embodiment shown in FIG. 14, the second local oscillator signal 272 is derived from the local oscillator signal 266 produced by the local oscillator 264 and a second signal (f2) that has a characteristic frequency different from the frequency of the local oscillator signal 266. In this process, a first phase-shifter 275 produces an in-quadrature version 276 of the local oscillator signal 266. A third mixer 278 mixes the second signal (f2) with the quadrature local oscillator signal 276 to produce a first modified local oscillator signal 280. A second phase-shifter 282 produces an in-quadrature version 284 of the second signal (f2). A fourth mixer 286 mixes the quadrature version 284 of the second signal (f2) with the in-phase local oscillator signal 266 to produce a second modified local oscillator signal 288. A summer 290 combines the first and second modified local oscillator signals 280, 288 to produce the second local oscillator signal 272.

### IV. Wireless Transceiver Embodiments

The wireless receiver embodiments and the wireless transmitter embodiments that are described herein may be incorporated singly into respective wireless communication devices that are configured for one-way wireless communications. Alternatively, one or more of the wireless receiver embodiments may be integrated with one or more of the wireless transmitter embodiments in wireless communication devices that are configured for two-way wireless communications. In some of these embodiments, the one or more wireless receiver embodiments may be integrated with the one or more wireless receiver embodiments on a single semiconductor chip.

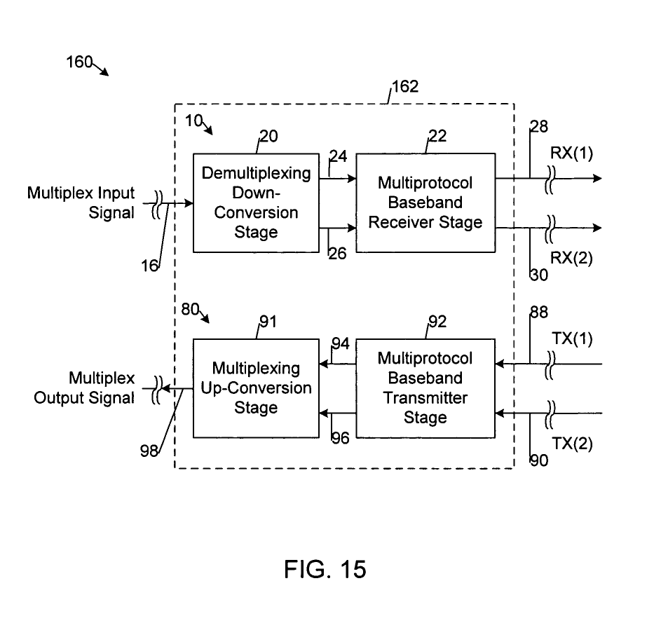

FIG. 15 shows an embodiment of a wireless transceiver 160 that includes the wireless receiver 10 (shown in FIG. 1) integrated with the wireless transmitter 80 (shown in FIG. 9) on a single semiconductor chip 162. In this embodiment, one or more of the components of the wireless receiver 10 and the wireless transmitter 80 may be shared. For example, in some implementations, the same local oscillator and phase-shifter may be used to generate the in-phase and in-quadrature local oscillator signals that are used by the demultiplexing down-conversion stage 20 of the wireless receiver and the multiplexing up-conversion stage 91 of the wireless transmitter 80.

### V. Conclusion

The embodiments that are described herein are capable of simultaneously communicating with multiple wireless environments in accordance with different wireless communications protocols. In particular, these embodiments are capable of transmitting and receiving multiplex signals that include constituent data-carrying signals that conform to different wireless communications protocols. In this way, these embodiments allow the overall data rate to be increased relative to approaches in which only one wireless communications protocol is enabled at a time.

Other embodiments are within the scope of the claims.

What is claimed is:

1. A wireless communication apparatus, comprising:
a demultiplexing down-conversion stage operable to receive a multiplex input signal comprising a first carrier modulated with a first data signal and a second carrier modulated with a second data signal, wherein the first and second carrier signals are in quadrature, the demultiplexing down-conversion stage being operable to down-convert the multiplex input signal to produce a first demultiplexed signal corresponding to the first data signal in a baseband frequency range, the demultiplexing down-conversion stage being additionally operable to down-convert the multiplex input signal to produce a second demultiplexed signal corresponding to the second data signal in the baseband frequency range; and
a multiprotocol baseband receiver stage operable to produce from the first demultiplexed signal a first receive data signal that conforms to a first wireless communications protocol, the multiprotocol baseband receiver stage being additionally operable to produce from the second demultiplexed signal a second receive data signal that conforms to a second wireless communications protocol different from the first wireless communications protocol.

2. The apparatus of claim 1, wherein the demultiplexing down-conversion stage comprises:
a first mixer operable to produce the first demultiplexed signal by mixing the multiplex input signal with an in-phase local oscillator signal;
a second mixer operable to produce the second demultiplexed signal by mixing the multiplex input signal with an in-quadrature version of the local oscillator signal;
a local oscillator coupled to the first mixer and operable to produce the local oscillator signal; and
a phase-shifter coupled between the local oscillator and the second mixer and operable to produce the in-quadrature version of the local oscillator signal from the in-phase local oscillator signal.

3. The apparatus of claim 1, wherein the multiprotocol baseband receiver stage is operable to reject interferers in the first demultiplexed signal outside a selected first channel frequency range to produce a first baseband receive signal, and the multiprotocol baseband receiver stage is operable to reject interferers in the second demultiplexed signal outside a selected second channel frequency range to produce a second baseband receive signal.

4. The apparatus of claim 3, wherein the multiprotocol baseband receiver stage comprises a first filter circuit and a second filter circuit, the first filter circuit having a tunable frequency response configured to filter the first demultiplexed signal compatibly with the first wireless communications protocol to produce a first filtered signal, and the second filter circuit having a tunable frequency response configured to filter the second demultiplexed signal compatibly with the second wireless communications protocol to produce a second filtered signal.

5. The apparatus of claim 4, wherein the multiprotocol signal processing stage additionally comprises a first amplification circuit and a second amplification circuit, the first amplification circuit being operable to amplify the first filtered signal compatibly with the first wireless communications protocol to produce the first baseband receive signal, and the second amplification circuit being operable to amplify the second filtered signal compatibly with the second wireless communications protocol to produce the second baseband receive signal.

6. The apparatus of claim 5, wherein the multiprotocol signal processing stage comprises a gain controller operable to produce output signals indicative of respective power levels of the first and second baseband receive signals, and further comprising a digital signal processing stage operable to distinguish the first and second baseband receive signals from each other based on the output signals produced by the gain controller.

7. The apparatus of claim 1, further comprising a digital signal processing stage operable to detect a header in the first and second baseband receive signals and to distinguish the first and second baseband receive signals from each other based on detection of the header in one of the first and second baseband receive signals and failure to detect the header in the other one of the first and second baseband receive signals.

8. The apparatus of claim 1, further comprising a second demultiplexing down-conversion stage operable to down-convert the multiplex input signal to produce third and fourth demultiplexed signals in quadrature at a baseband frequency different from baseband frequency of the first and second demultiplexed signals.

9. The apparatus of claim 1, further comprising:
a multiprotocol baseband transmitter stage operable to produce a first baseband transmit signal from a first transmit data signal that conforms to a first wireless communications protocol, the multiprotocol baseband transmitter stage being additionally operable to produce a second baseband transmit signal from a second transmit data signal that conforms to a second wireless communications protocol different from the first wireless communications protocol; and
a multiplexing up-conversion stage coupled to the multiprotocol baseband transmitter stage and operable to up-convert the first baseband transmit signal to a first up-converted signal in a selected wireless transmission frequency range, the multiplexing up-conversion stage being operable to up-convert the second baseband transmit signal to a second up-converted signal in the selected wireless transmission frequency range, wherein the first and second up-converted signals are in quadrature, the multiplexing up-conversion stage being additionally operable to combine the first and second up-converted signals into a multiplex output signal.

10. A wireless communication apparatus, comprising:
a multiprotocol baseband transmitter stage operable to produce a first baseband transmit signal from a first transmit data signal that conforms to a first wireless communications protocol, the multiprotocol baseband transmitter stage being additionally operable to produce a second baseband transmit signal from a second transmit data signal that conforms to a second wireless communications protocol different from the first wireless communications protocol; and
a multiplexing up-conversion stage coupled to the multiprotocol baseband transmitter stage and operable to up-convert the first baseband transmit signal to a first up-converted signal in a selected wireless transmission frequency range, the multiplexing up-conversion stage being operable to up-convert the second baseband transmit signal to a second up-converted signal in the selected wireless transmission frequency range, wherein the first and second up-converted signals are in quadrature, the multiplexing up-conversion stage being additionally operable to combine the first and second up-converted signals into a multiplex output signal.

11. The apparatus of claim 10, wherein the multiplexing up-conversion stage comprises:
a first mixer operable to produce the first up-converted signal by mixing the first baseband transmit signal with an in-phase local oscillator signal;
a second mixer operable to produce the second up-converted signal by mixing the second baseband transmit signal with an in-quadrature version of the local oscillator signal;
a local oscillator coupled to the first mixer and operable to produce the local oscillator signal; and
a phase-shifter coupled between the local oscillator and the second mixer the phase-shifter and operable to produce the in-quadrature version of the local oscillator signal from the in-phase local oscillator signal.

12. The apparatus of claim 10, wherein the multiprotocol baseband transmitter stage is operable to filter and amplify the first transmit data signal compatibly with the first wireless communications protocol to produce the first baseband transmit signal, and the multiprotocol baseband transmitter stage is operable to filter and amplify the second transmit data signal compatibly with the second wireless communications protocol to produce the second baseband transmit signal.

13. The apparatus of claim 10, wherein the multiplexing up-conversion stage is operable to up-convert the first and second baseband signals such that the first and second up-converted signals have different respective channel frequencies.

14. A wireless communication method, comprising:
receiving a multiplex input signal comprising a first carrier modulated with a first data signal and a second carrier modulated with a second data signal, wherein the first and second carrier signals are in quadrature;
down-converting the multiplex input signal to produce a first demultiplexed signal corresponding to the first data signal in a baseband frequency range;
down-converting the multiplex input signal to produce a second demultiplexed signal corresponding to the second data signal in the baseband frequency range;
producing from the first demultiplexed signal a first receive data signal that conforms to a first wireless communications protocol; and
producing from the second demultiplexed signal a second receive data signal that conforms to a second wireless communications protocol different from the first wireless communications protocol.

15. The method of claim 14, wherein the producing of the first receive data signal comprises rejecting interferers in the first demultiplexed signal outside a selected first channel frequency range to produce a first baseband receive signal, and the producing of the second receive data signal comprises rejecting interferers in the second demultiplexed signal outside a selected second channel frequency range to produce a second baseband receive signal.

16. The method of claim 15, wherein the rejecting of interferers in the first demultiplexed signal comprises filtering the first demultiplexed signal compatibly with the first wireless communications protocol to produce a first filtered signal, and the rejecting of interferers in the second demultiplexed signal comprises filtering the second demultiplexed signal compatibly with the second wireless communications protocol to produce a second filtered signal.

17. The method of claim 16, wherein the producing of the first receive data signal additionally comprises amplifying the first filtered signal compatibly with the first wireless communications protocol to produce the first baseband receive signal, and the producing of the second receive data signal additionally comprises amplifying the second filtered signal compatibly with the second wireless communications protocol to produce the second baseband receive signal.

18. The method of claim 14, further comprising:
producing a first baseband transmit signal from a first transmit data signal that conforms to a first wireless communications protocol;
producing a second baseband transmit signal from a second transmit data signal that conforms to a second wireless communications protocol different from the first wireless communications protocol;
up-converting the first baseband transmit signal to produce a first up-converted signal in an RF frequency range;
up-converting the second baseband transmit signal to produce a second up-converted signal in the RF frequency range, wherein the first and second up-converted signals are in quadrature; and
combining the first and second up-converted signals into a multiplex output signal.

19. A wireless communication method, comprising:
producing a first baseband transmit signal from a first transmit data signal that conforms to a first wireless communications protocol;
producing a second baseband transmit signal from a second transmit data signal that conforms to a second wireless communications protocol different from the first wireless communications protocol;
up-converting the first baseband transmit signal to produce a first up-converted signal in an RF frequency range;
up-converting the second baseband transmit signal to produce a second up-converted signal in the RF frequency range, wherein the first and second up-converted signals are in quadrature; and
combining the first and second up-converted signals into a multiplex output signal.

20. The method of claim 18, wherein the producing of the first baseband transmit signal comprises filtering and amplifying the first transmit data signal compatibly with the first wireless communications protocol, and the producing of the second baseband transmit signal comprises filtering and amplifying the second transmit data signal compatibly with the second wireless communications protocol.
